(19) United States
(12) Patent Application Publication
(10) Pub. No.: US 2021/0126742 A1
(43) Pub. Date: Apr. 29, 2021

(54) USER TERMINAL AND RADIO BASE STATION

(71) Applicant: NTT DOCOMO, INC., Tokyo (JP)

(72) Inventors: Shohei Yoshioka, Tokyo (JP); Yuki Matsumura, Tokyo (JP); Kazuki Takeda, Tokyo (JP); Satoshi Nagata, Tokyo (JP)

(73) Assignee: NTT DOCOMO, INC., Tokyo (JP)

(21) Appl. No.: 17/047,612

(22) PCT Filed: Apr. 15, 2019
(86) PCT No.: PCT/JP2019/016141

§ 371 Date: Oct. 14, 2020

(30) Foreign Application Priority Data
Apr. 16, 2018 (JP) 2018-089524

(51) Int. Cl. H04L 1/18; H04W 74/08; H04W 72/04; H04W 88/02; H04W 88/08

(52) U.S. Cl. CPC H04L 1/189; H04W 74/0833; H04W 72/0413; H04W 88/08; H04W 72/0446; H04W 72/0453; H04W 88/02

(57) ABSTRACT

A user terminal includes: a transmitting section that transmits an uplink signal before connection establishment; and a control section that controls a repeated transmission of the uplink signal based on configuration information reported implicitly. According to an aspect of the present disclosure, repeated transmission before connection establishment is appropriately controlled.

### TECHNICAL FIELD

The present invention relates to a user terminal and a radio base station in next-generation mobile communication systems.

### BACKGROUND ART

In the UMTS (Universal Mobile Telecommunications System) network, the specifications of long-term evolution (LTE) have been drafted for the purpose of further increasing high speed data rates, providing lower delays, and so on (see Non Patent Literature 1). In addition, successor systems of LTE are also under study for the purpose of achieving further broadbandization and increased speed beyond LTE (referred to as, for example, “LTE-A (LTE-Advanced)”, “FRA (Future Radio Access)”, “4G”, “5G”, “5G+ (plus)”, “NR (New RAT)”, “LTE Rel. 15 and after (or later versions)”, and the like).

In the existing LTE systems (for example, LTE Rel. 8 to 13), downlink (DL) and/or uplink (UL) communication are performed using 1-ms subframes (also referred to as “transmission time intervals (TTIs)” and the like). Such a subframe is a unit of time of transmitting one channel-encoded data packet, and serves as a unit of processing in, for example, scheduling, link adaptation, retransmission control (HARQ (Hybrid Automatic Repeat reQuest)), and the like.

Further, in the existing LTE systems (for example, LTE Rel. 8 to 13), a user terminal transmits uplink control information (UCI) by using an uplink control channel (for example, a PUCCH (Physical Uplink Control Channel)) or an uplink shared channel (for example, a PUSCH (Physical Uplink Shared Channel)). The configuration (format) of this uplink control channel is called “PUCCH format” or the like.

### CITATION LIST

### Non Patent Literature

Non Patent Literature 1: 3GPP TS 36.300 V8.12.0 “Evolved Universal Terrestrial Radio Access (E-UTRA) and Evolved Universal Terrestrial Radio Access Network (E-UTRAN); Overall description; Stage 2 (Release 8),” April 2010

### SUMMARY OF INVENTION

### Technical Problem

In the future radio communication systems (for example, LTE Rel. 15 or later, 5G, 5G+, NR, and the like), a method of allocating resources (for example, PUCCH resources) for uplink control channels for use in UCI transmission to user terminals is under study.

For example, before setup of the RRC (Radio Resource Control) connection, what is under study is to cause each of the user terminals to determine the PUCCH resources for use in the UCI transmission on the basis of at least one of a certain field value in system information (for example, RMSI: Remaining Minimum System Information) and a certain field value and an implicit value in downlink control information (DCI: Downlink Control Information).

However, in the above PUCCH resource determination method, repeated transmission (repetition) may not be able to be appropriately performed.

The present invention has been made in view of the above point, and an object of the present invention is to provide a user terminal and a radio base station, which appropriately control the repeated transmission before establishment of a connection.

### Solution to Problem

A user terminal according to an aspect of the present invention includes: a transmitting section that transmits an uplink signal before establishment of a connection; and a control section that controls the repeated transmission of the uplink signal based on configuration information reported implicitly.

### Advantageous Effects of Invention

According to the present invention, the repeated transmission before the establishment of the connection can be controlled appropriately.

### BRIEF DESCRIPTION OF DRAWINGS

FIG. 1 is a diagram illustrating an example of PUCCH resources indicated by RMSI index values.

FIG. 2 is a diagram illustrating an example of PUCCH resources for each PUCCH format indicated by ARI.

FIG. 3 is a diagram illustrating an example of an operation before setup of an RRC connection.

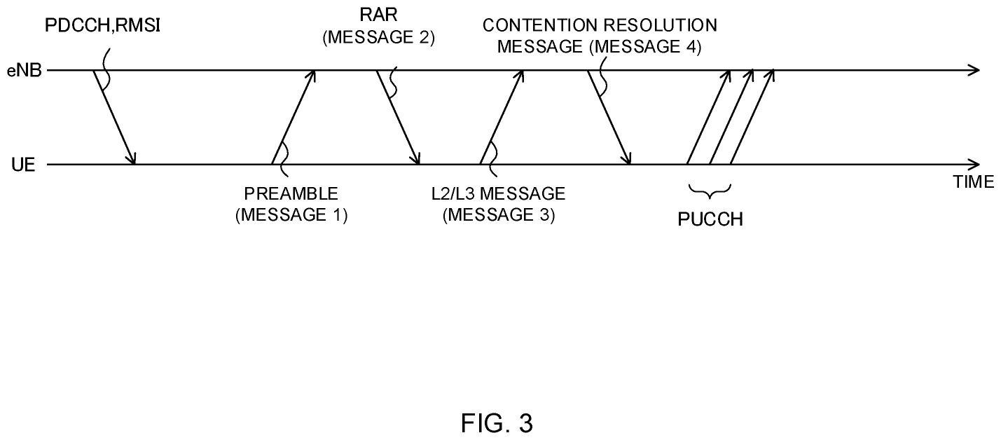

FIG. 4 is a diagram illustrating an example of a schematic configuration of a radio communication system according to the present embodiment.

FIG. 5 is a diagram illustrating an example of an overall configuration of a radio base station according to the present embodiment.

FIG. 6 is a diagram illustrating an example of a functional configuration of the radio base station according to the present embodiment.

FIG. 7 is a diagram illustrating an example of an overall configuration of a user terminal according to the present embodiment.

FIG. 8 is a diagram illustrating an example of a functional configuration of the user terminal according to the present embodiment.

FIG. 9 is a diagram illustrating an example of a hardware configuration of the radio base station and the user terminal according to the present embodiment.

### DESCRIPTION OF EMBODIMENTS

In the future radio communication systems (for example, LTE Rel. 15 or later, 5G, NR, and the like), configurations (also referred to as formats, PUCCH formats (PFs) and the like) for uplink control channels (for example, PUCCH) for use in UCI transmission are under study. For example, in LTE Rel. 15, it is under study to support five types of PFs which are PF0 to PF4. PF names shown below are merely examples, and different names may be used.

For example, PF0 and PF1 are PFs for use in transmitting UCI of 2 bits or less (up to 2 bits) (for example, also referred to as delivery confirmation information (HARQ-ACK: Hybrid Automatic Repeat reQuest-Acknowledge, ACK, NACK, or the like)). Since it is possible to allocate PF0 to 1 or 2 symbols, PF0 is also called a short PUCCH, a sequence-based short PUCCH or the like. Meanwhile, since it is possible to allocate PF1 to 4 to 14 symbols, PF1 is also called a long PUCCH or the like. In PF1, by block spreading in a time domain, which uses at least one of CS and OCC, a plurality of user terminals may be subjected to code division multiplexing (CDM) in the same physical resource block (PRB; also referred to as a resource block (RB) or the like).

PF2 to PF4 are PFs for use in transmitting UCI exceeding 2 bits (of more than 2 bits). For example, UCI is channel state information (CSI) or CSI and HARQ-ACK and/or a scheduling request (SR). Since it is possible to allocate PF2 to 1 or 2 symbols, PF2 is also called a short PUCCH or the like. Meanwhile, since it is possible to allocate PF3 and PF4 to 4 to 14 symbols, PF3 and PF4 are also called long PUCCHs or the like. In PF4, a plurality of user terminals may be subjected to CDM using block spreading in a (frequency domain) before DFT.

Allocation of resources (for example, PUCCH resources) for use in transmission of the uplink control channel is performed using upper layer signaling and/or downlink control information (DCI). Here, for example, the upper layer signaling just needs to be at least one of RRC (Radio Resource Control) signaling, system information (for example, at least one of RMSI: Remaining Minimum System Information, OSI: Other System Information, MIB: Master Information Block, and SIB: System Information Block), and broadcast information (PBCH: Physical Broadcast Channel).

«After Setup of RRC Connection»

After setup of an RRC connection, one or more sets (PUCCH resource sets) each including one or more PUCCH resources are reported (configured) to the user terminal by upper layer signaling (for example, RRC signaling). For example, to the user terminal, K pieces (for example, 1≤K≤4) PUCCH resource sets may be reported from a radio base station (for example, gNB: gNodeB, eNB: eNodeB, a network, a transmission/reception point, and the like).

Each PUCCH resource set may include M (for example, 4≤M≤8) pieces of PUCCH resources. Each of the K·M pieces of PUCCH resources may be configured in the user terminal by the upper layer signaling (for example, RRC signaling).

The user terminal may determine a single PUCCH resource set from the K pieces of configured PUCCH resource sets based on a certain rule (for example, payload size of UCI (UCI payload size)). The UCI payload size may be the number of UCI bits that do not include Cyclic Redundancy Code (CRC) bits.

From the M pieces of PUCCH resources included in the determined PUCCH resource set, the user terminal may determine the PUCCH resource for use in the transmission of UCI based on at least one of DCI and implicit value (implicit indication or an implicit index, also referred to as a derived value at the user terminal, a certain value, or the like).

«Before Setup of RRC Connection»

Meanwhile, before the setup of the RRC connection, at least one PUCCH resource cannot be configured (reported) to the user terminal using the RRC signaling. On the other hand, it is assumed that UCI transmission is required even before the setup of the RRC connection.

For example, before the setup of the RRC connection, a random access procedure is performed between the user terminal and the radio base station.

(1) The user terminal transmits a preamble (also referred to as a random access preamble, a random access channel (PRACH: Physical Random Access Channel), Message 1 (Msg. 1), or the like).

(2) Upon detecting the preamble, the radio base station transmits a random access response (RAR, also referred to as Message 2 or the like).

(3) The user terminal establishes uplink synchronization based on timing advance (TA) included in Message 2 and transmits a control message (Message 3) of upper layers (L2/L3) using PUSCH. The control message includes an identifier of the user terminal (which is, for example, C-RNTI (Cell-Radio Network Temporary Identifier)).

(4) The radio base station transmits a contention resolution message (Message 4) using PDSCH in response to the control message of the upper layers.

(5) The user terminal transmits HARQ-ACK of Message 4 to the radio base station using PUCCH.

Thereafter, the RRC connection is set up in the user terminal.

The random access procedure exemplified as above requires transmission of UCI including HARQ-ACK for Message 4, and a problem is how the user terminal determines the PUCCH resource for use in the transmission of this UCI.

Accordingly, before the setup of the RRC connection, what is under study is to cause the user terminal to select the PUCCH resource for use in the transmission of UCI from among one or more PUCCH resources (also referred to as a PUCCH resource candidate and a PUCCH resource set) indicated by an index value (also referred to as a certain field value, a certain value, and the like) in the system information (for example, RMSI) based on a bit value in DCI (also referred to as a certain field value, index value, certain value, and the like) and/or an implicit value.

This bit value of DCI is, for example, a 2-bit bit value, where it is under study to make it possible to select four types of PUCCH resources.

Further, the implicit value may be derived, for example, based on at least one of the following parameters.

Index of a control resource unit (CCE: Control Resource Element)

Index of a control resource set (CORESET)

Index of a search space

Index (for example, start index) of a frequency resource allocated to PDSCH (for example, the frequency resource is PRG: Precoding Resource Block Group, RBG: Resource Block Group or PRB: Physical Resource Block)

Field value for transmission power control (TPC) command

Status (TCI status) of a transmission configuration indicator (TCI) of PDCCH and/or PDSCH

Number of bits of UCI

Configuration information of a demodulation reference signal (DMRS) of PDCCH and/or PDSCH

Type of codebook for HARQ-ACK

For example, before the setup of the RRC connection, one of a plurality of PUCCH resources is specified by a certain field value (also referred to as an index value, an RMSI index value, a certain value, an identifier (indication), an RMSI identifier, a certain value, and the like) in RMSI. For example, 16 types of PUCCH resources are specified by 4-bit RMSI index values.

Each PUCCH resource indicated by the RMSI index value may include one or more cell-specific parameters. For example, the cell-specific parameter includes at least one of the following parameters and may include other parameters.

Information indicating a period (number of symbols, PUCCH period) allocated to PUCCH, for example, information indicating any one of 2, 4, 10, and 14 symbols

Information indicating an offset (PRB offset, frequency offset, cell-specific PRB offset) for use in determining frequency resources allocated to PUCCH when frequency hopping is applied

Starting symbol of PUCCH

Further, one of the plurality of PUCCH resources is designated by at least one of a certain field value (PUCCH resource indicator, an ACK/NACK resource indicator (ARI), an ACK/NACK resource offset (ARO), or TPC command field value) and the implicit value in DCI. For example, 16 types of PUCCH resources are specified by 3-bit ARI and a 1-bit implicit value in DCI.

Each PUCCH resource indicated by at least one of ARI and the implicit value may include one or more user terminal-specific (UE-specific) parameters. For example, the UE-specific parameters include at least one of the following parameters and may include other parameters.

Information (hopping direction) indicating from which direction of a certain bandwidth hopping is performed, for example, information (for example, “1”) indicating that a first hop is set to PRB with a small index number and a second hop is set to PRB with a large index number, or information (for example, “2”) indicating that the first hop is set to PRB with a large index number and a second hop is set to PRB with a small index number

Information indicating an offset (PRB offset, frequency offset, UE-specific PRB offset) for use in determining frequency resources allocated to PUCCH when frequency hopping is applied

Information indicating an index of an initial cyclic shift (CS)

Further, the above implicit value may be derived, for example, based on at least one of the following parameters. The implicit value may be any value that is derived without explicit signaling.

Index of a control resource unit (for example, CCE: Control Resource Element) to which a downlink control channel (for example, PDCCH: Physical Downlink Control Channel) is allocated

Aggregation level of the control resource unit

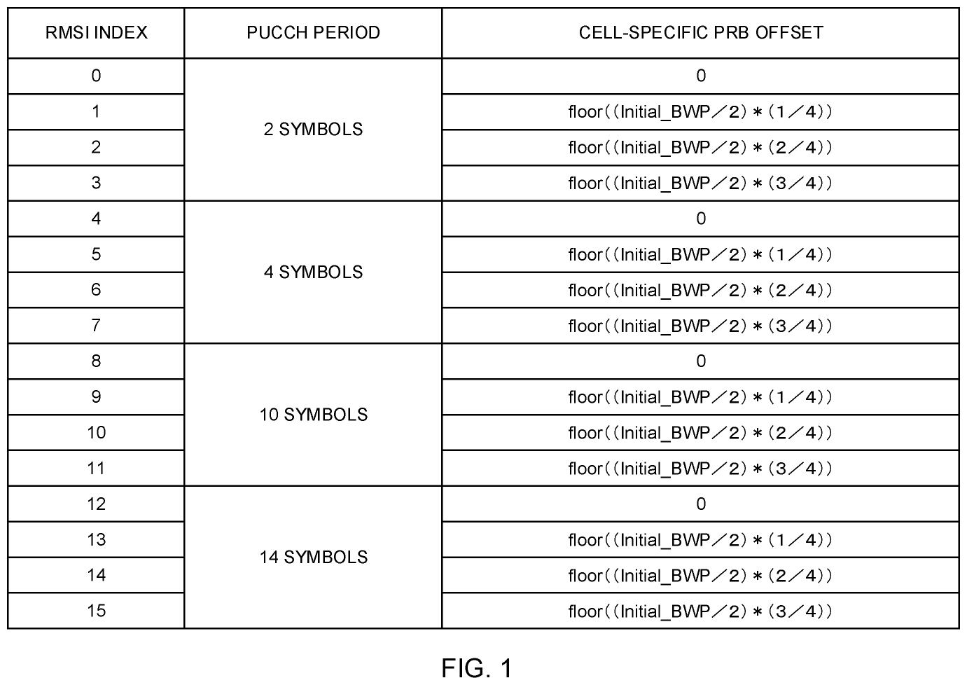

FIG. 1 is a diagram illustrating an example of the PUCCH resources indicated by the RMSI index values. For example, as illustrated in FIG. 1, each value of the 4-bit RMSI index may indicate a PUCCH period and a cell-specific PRB offset.

In such a future radio communication system, when frequency hopping is applied to a PUCCH, it is assumed that a frequency resource allocated to the PUCCH is a PRB separated by a certain offset value x from a PRB of each end (edge) of a certain band width (for example, a bandwidth part (BWP)).

Here, the BWP is a partial band configured within a carrier, and is called a partial band or the like. The BWP may include a BWP (UL BWP, uplink BWP) for an uplink (UL) and a BWP (DL BWP, downlink BWP) for a downlink (DL). An uplink BWP for random access (initial access) may be called an initial_BWP, an initial uplink BWP, an initial access BWP, or the like.

Further, a downlink BWP for use in detection of a block (also referred to as SSB: Synchronization Signal Block or SS/PBCH block: Synchronization Signal/Physical Broadcast Channel Block or the like) including a synchronization signal and a broadcast channel may be called an initial downlink BWP or the like.

Further, when one or more BWPs (at least one of one or more uplink BWPs and one or more downlink BWPs) are configured in the user terminal, at least one BWP may be activated. The BWP in an active state may also be called an active BWP (active uplink BWP or active downlink BWP) or the like. Further, a default BWP (default uplink BWP or default downlink BWP) may be configured in the user terminal.

For example, it is assumed that the frequency resource of the first hop is composed of a certain number of PRBs separated from one end of a certain bandwidth (for example, initial access BWP) by a certain offset value x, and that the frequency resource of the second hop is composed of a certain PRBs separated from the other end of the certain bandwidth by the certain offset value x.

Further, the certain offset value x is derived based on at least one of the cell-specific PRB offset indicated by the RMSI index value and the UE-specific PRB offset indicated by ARI. For example, the certain offset value x=cell-specific PRB offset+UE-specific PRB offset may be used.

In FIG. 1, as the cell-specific PRB offset, there are shown four values, which are {0, floor((Initial_BWP/2)*(1/4)), floor((Initial_BWP/2)*(2/4)), floor((Initial_BWP/2)*(3/4))}. Here, Initial_BWP may be the number of PRBs which form the initial access BWP.

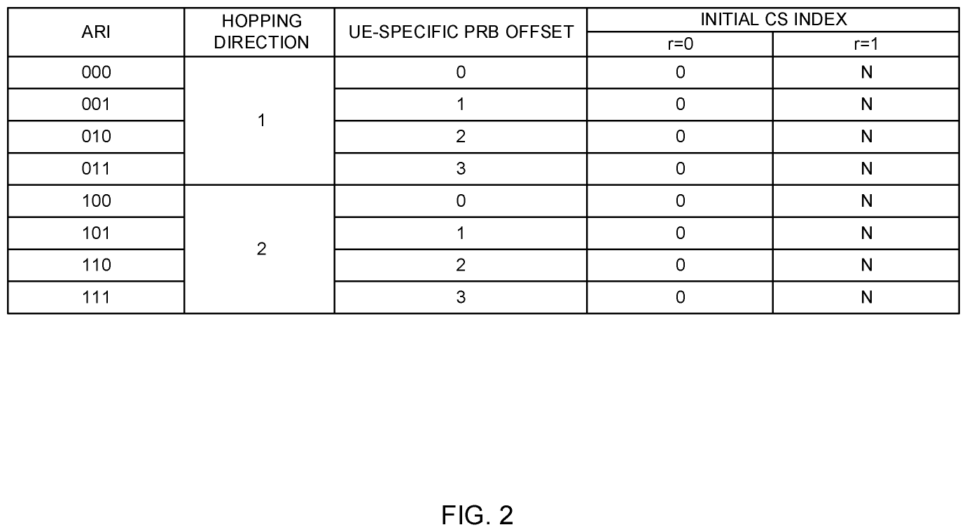

FIG. 2 is a diagram illustrating an example of the PUCCH resources indicated by ARI.

For example, as illustrated in FIG. 2, a 3-bit ARI may indicate a hopping direction, a UE-specific PRB offset, and a plurality of initial CS indices. The user terminal may derive, for example, a 1-bit value r (implicit value) based on CCE indices and determine one of the plurality of initial CS indices based on this value r. Regarding an initial CS index N, for example, N=3 may be specified for PF0 and N=6 may be specified for PF1.

By the way, in UE after the setup (connected) of the RRC connection (connected), the number of slots (number of PUCCH slots, number of PUCCH repetitions) N_{PUCCH}^{repeat} for PUCCH transmission may be configured by upper layer parameters (for example, PUCCH-F1-number-of-slots for PF1, PUCCH-F3-number-of-slots for PF3, or PUCCH-F4-number-of-slots for PF4). When N_{PUCCH}^{repeat} is greater than 1, the UE transmits PUCCH over a plurality of slots (N_{PUCCH}^{repeat} slots).

The UE repeats UCI in the PUCCH transmission in the first slot of the Nᵣₑₚₑₐₜ slots in each PUCCH transmission of the remaining Nᵣₑₚₑₐₜ−1 slots.

However, details of the repeated transmission (repetition) of the uplink signal (PUCCH) before the establishment of the connection (before the setup of the RRC connection) have not been determined yet. Therefore, the inventors of the present invention have studied an operation of repeated transmission of PUCCH in the initial access, and have reached the present invention.

Now, the present embodiment will be described below in detail.

(Aspect)

The control of the repeated transmission of the uplink signal before the RRC connection will be described.

A case where the uplink signal is the PUCCH before the RRC connection will be described below. This aspect may be applied to another uplink signal (PUSCH or the like) before the RRC connection.

Further, a case will be described where the PUCCH carries UCI indicating HARQ (Hybrid Automatic Repeat reQuest)-ACK (acknowledgment) for Msg. 4. PUCCH may carry other UCIs. HARQ-ACK may be called delivery confirmation information, ACK, or the like. HARQ-ACK may be carried by PUSCH.

Configuration information (parameters, configuration) for the repeated transmission of PUCCH may be implicitly reported to UE. The configuration information may indicate at least one parameter of as to whether or not to perform the repeated transmission (the repeated transmission is valid), the number of repetitions, and an RV (Redundancy Version) sequence (type of RV sequence, index) for the repeated transmission.

The configuration information may be implicitly reported by at least one information of CCE, DAI (Downlink Assignment Indicator (Index)), Msg. 2, Msg. 3, and Msg. 4. At least one value (for example, field) in this information may be associated with at least one parameter for the repeated transmission.

CCE may be a CCE index of PDCCH. PDCCH may be PDCCH for scheduling at least one of RMSI, Msg. 2, and Msg. 4.

DAI may be DAI included in DCI sent by PDCCH, or may be at least one of a counter DAI and a total DAI. PDCCH may be PDCCH for scheduling at least one of RMSI, Msg. 2, and Msg. 4.

When the repeated transmission is configured to UE according to the configuration information, UE may perform the repeated transmission in all subsequent transmissions before the RRC connection.

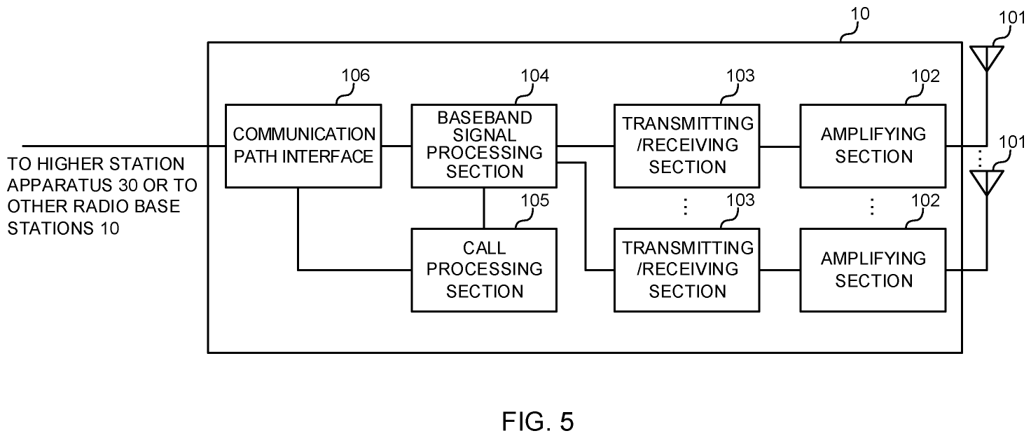

When the repeated transmission is configured to UE according to the configuration information, and UE supports the repeated transmission, UE may transmit a plurality of PUCCHs as illustrated in FIG. 5.

When the repeated transmission is configured to UE according to the configuration information, and UE does not support the repeated transmission, UE may transmit a single PUCCH (does not have to perform the repeated transmission). For example, as illustrated in FIG. 5, when a plurality of resources for the repeated transmission are configured to UE by the configuration information, a single PUCCH may be transmitted using only a first resource (most forward resource). Further, for example, as illustrated in FIG. 5, when the plurality of resources for the repeated transmission are configured to UE by the configuration information, a single PUCCH may be transmitted using only a certain resource (resource with a certain number, a last resource, and the like).

The radio base station may decode the first PUCCH in the repeated transmission. When the decoding fails, a plurality of PUCCHs may be combined (for example, soft-combined), and a result of the combination may be decoded again. For example, when the radio base station fails to decode the first PUCCH, the radio base station may combine the first PUCCH with at least one PUCCH among the second PUCCH and after, and may decode a result of the combination again. Moreover, the radio base station may combine and decode all of the plurality of PUCCHs which are repeatedly transmitted. In this way, the radio base station can flexibly perform the decoding.

By repeatedly transmitting PUCCH before the RRC connection, performance of an initial access can be improved. Further, even if such repeated transmission is not performed, there is no influence such as contention. The configuration information is reported to UE implicitly, whereby an overhead in reporting the configuration information can be suppressed, and consumption of the resources can be suppressed.

(Radio Communication System)

Now, a configuration of a radio communication system according to the present embodiment will be described below. In this radio communication system, a radio communication method according to each of the above aspects is applied. The radio communication method according to each of the above aspects may be applied independently, or may be applied in combination of at least two thereof.

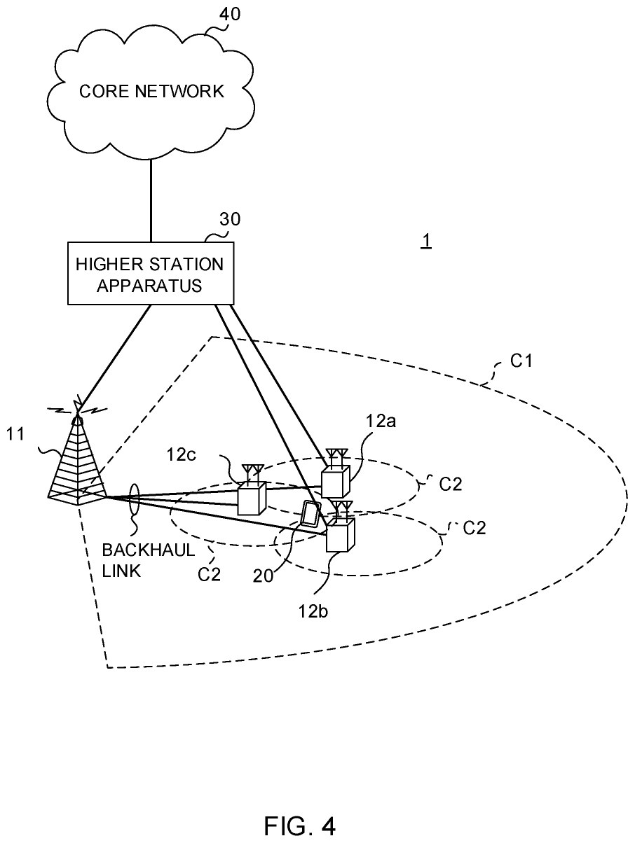

FIG. 4 is a diagram illustrating an example of a schematic configuration of the radio communication system according to the present embodiment. A radio communication system 1 can adopt dual connectivity (DC) and/or carrier aggregation (CA) in which a plurality of fundamental frequency blocks (component carriers) each having, as one unit, a system bandwidth (for example, 20 MHz) of an LTE system are integrated with one another. The radio communication system 1 may be called SUPER 3G, LTE-A (LTE-Advanced), IMT-Advanced, 4G, 5G, FRA (Future Radio Access), NR (New RAT: New Radio Access Technology), or the like.

The radio communication system 1 illustrated in this drawing includes a radio base station 11 that forms a macro cell C1, and radio base stations 12a to 12c which are placed within the macro cell C1 and form small cells C2 narrower than the macro cell C1. Further, user terminals 20 are placed in the macro cell C1 and the respective small cells C2. Such a configuration in which different numerologies are applied between cells and/or within cells may be adopted.

Here, the numerology is a communication parameter in the frequency direction and/or the time direction (for example, the numerology is at least one of a subcarrier interval, a bandwidth, a symbol length, a CP time length (CP length), a subframe length, a TTI time length (TTI length), the number of symbols per TTI, a radio frame configuration, filtering processing, windowing processing, and the like). In the radio communication system 1, for example, a subcarrier interval such as 15 kHz, 30 kHz, 60 kHz, 120 kHz, and 240 kHz may be supported.

The user terminal 20 can connect to both the radio base station 11 and the radio base stations 12. It is assumed that the user terminal 20 uses the macro cell C1 and the small cells C2, which use different frequencies, simultaneously by means of CA or DC. Moreover, the user terminal 20 can apply CA or DC using a plurality of cells (CCs) (for example, two or more CCs). Further, the user terminal can use a licensed band CC and an unlicensed band CC as the plurality of cells.

Moreover, the user terminal 20 can perform communication in each cell using time division duplex (TDD) or frequency division duplex (FDD). Such a TDD cell and such an FDD cell may be called a TDD carrier (frame configuration type 2), and an FDD carrier (frame configuration type 1), respectively.

Further, in each cell (carrier), a single numerology may be applied, or a plurality of different numerologies may be applied.

Between the user terminal 20 and the radio base station 11, communication can be carried out using a carrier with a narrow bandwidth in a relatively low frequency band (for example, 2 GHz) (this carrier is also called an existing carrier, a legacy carrier, and the like). Meanwhile, between the user terminal 20 and the radio base stations 12, a carrier with a wide bandwidth in a relatively high frequency band (for example, 3.5 GHz, 5 GHz, 30 to 70 GHz, and the like) may be used, or the same carrier as that for use between the radio base station 11 and the user terminal 20 may be used. The configuration of the frequency band for use in each radio base station is by no means limited to these.

A configuration can be adopted here in which wired connection (for example, optical fiber in compliance with CPRI (Common Public Radio Interface), X2 interface, and the like) or wireless connection is established between the radio base station 11 and the radio base station 12 (or between two radio base stations 12).

The radio base station 11 and the radio base stations 12 are each connected to a higher station apparatus 30, and are connected to a core network 40 via the higher station apparatus 30. The higher station apparatus 30 includes, for example, an access gateway apparatus, a radio network controller (RNC), a mobility management entity (MME), and the like, but is by no means limited to these. Further, each radio base station 12 may be connected to the higher station apparatus 30 via the radio base station 11.

The radio base station 11 is a radio base station having a relatively wide coverage, and may be called a macro base station, a central node, eNB (eNodeB), gNB (gNodeB), a transmitting/receiving point (TRP), and the like. Further, each of the radio base stations 12 is a radio base station having a local coverage, and may be called a small base station, a micro base station, a pico base station, a femto base station, HeNBs (Home eNodeBs), RRHs (Remote Radio Heads), eNB, gNB, a transmitting/receiving point, and the like. Hereinafter, the radio base stations 11 and 12 will be collectively referred to as radio base stations 10 unless these are distinguished from each other.

Each user terminal 20 is a terminal that supports various communication methods such as LTE, LTE-A, 5G, and NR, and may include not only a mobile communication terminal but also a stationary communication terminal. Further, the user terminal 20 can perform inter-terminal communication (D2D) with another user terminal 20.

In the radio communication system 1, as a radio access method, OFDMA (Orthogonal Frequency Division Multiple Access) can be applied to the downlink (DL), and SC-FDMA (Single Carrier-Frequency Division Multiple Access) can be applied to the uplink (UL). OFDMA is a multi-carrier communication method of performing communication by dividing a frequency band into a plurality of narrow frequency bands (subcarriers) and mapping data to the respective subcarriers. SC-FDMA is a single-carrier communication method of reducing an interference between terminals by dividing, for each of terminals, a system bandwidth into bands formed of one or continuous resource blocks, and causing a plurality of terminals to use mutually different bands. The uplink and downlink radio access methods are not limited to combinations of these, and OFDMA may be used in UL.

Further, in the radio communication system 1, a multi-carrier waveform (for example, an OFDM waveform) may be used, or a single carrier waveform (for example, a DFT-s-OFDM waveform) may be used.

In the radio communication system 1, as DL channels, there are used a DL shared channel (also referred to as PDSCH (Physical Downlink Shared Channel), DL data channel, and the like), which is shared by the respective user terminals 20, a broadcast channel (PBCH (Physical Broadcast Channel)), L1/L2 control channels, and the like. User data, upper layer control information, and SIBs (System Information Blocks) are transmitted by PDSCH. Further, MIB (Master Information Block) is transmitted by PBCH.

The L1/L2 control channels include DL control channels (PDCCH (Physical Downlink Control Channel), and EPDCCH (Enhanced Physical Downlink Control Channel)), PCFICH (Physical Control Format Indicator Channel), PHICH (Physical Hybrid-ARQ Indicator Channel), and the like. Downlink control information (DCI) including scheduling information of PDSCH and PUSCH, or the like is transmitted by PDCCH. The number of OFDM symbols for use in PDCCH is transmitted by PCFICH. EPDCCH is frequency-division-multiplexed with PDSCH, and like PDCCH, is used for transmitting DCI and the like. Retransmission control information (ACK/NACK) of HARQ for PUSCH can be transmitted by at least one of PHICH, PDCCH, and EPDCCH.

In the radio communication system 1, as UL channels, used are a UL shared channel (also referred to as PUSCH: Physical Uplink Shared Channel, an uplink shared channel, and the like), which is shared by the respective user terminals 20, an uplink control channel (PUCCH: Physical Uplink Control Channel), a random access channel (PRACH: Physical Random Access Channel), and the like. User data and upper layer control information are transmitted by PUSCH. Uplink control information (UCI: Uplink Control Information) including at least one of retransmission control information (A/N) of a DL signal and channel state information (CSI) and so on is transmitted by PUSCH or PUCCH. By means of PRACH, random access preambles for establishing connections with cells can be transmitted.

<Radio Base Station>

FIG. 5 is a diagram illustrating an example of an overall configuration of the radio base station according to the present embodiment. A radio base station 10 includes a plurality of transmitting/receiving antennas 101, amplifying sections 102, transmitting/receiving sections 103, a baseband signal processing section 104, a call processing section 105, and a communication path interface 106. Each of the transmitting/receiving antennas 101, the amplifying sections 102, and the transmitting/receiving sections 103 may be composed to include one or more thereof.

User data to be transmitted from the radio base station 10 to the user terminal 20 by DL is input from the higher station apparatus 30 to the baseband signal processing section 104 via the communication path interface 106.

In the baseband signal processing section 104, the user data is subjected to transmission processing, including processing of a PDCP (Packet Data Convergence Protocol) layer, division and coupling of the user data, RLC (Radio Link Control) layer transmission processing such as RLC retransmission control, MAC (Medium Access Control) retransmission control (for example, HARQ (Hybrid Automatic Repeat reQuest) transmission processing), scheduling, transmission format selection, channel coding, inverse fast Fourier transform (IFFT) processing, and precoding processing, and a result is transferred to each transmitting/receiving section 103. Furthermore, downlink control signals are also subjected to transmission processing such as channel coding and inverse fast Fourier transform, and are transferred to the transmitting/receiving sections 103.

Each of the transmitting/receiving sections 103 converts a baseband signal, which is pre-coded for each antenna and output from the baseband signal processing section 104, into a signal in a radio frequency band, and transmits such a radio frequency signal. The radio frequency signal subjected to frequency conversion in the transmitting/receiving section 103 is amplified by the amplifying section 102, and is transmitted from the transmitting/receiving antenna 101.

The transmitting/receiving section 103 can be composed of a transmitter/receiver, a transmitting/receiving circuit, or a transmitting/receiving apparatus, which is described based on common understanding in the technical field according to the present invention. The transmitting/receiving section 103 may be composed of an integrated transmitting/receiving section, or may be composed of a transmitting section and a receiving section.

Meanwhile, as for each UL signal, a radio frequency signal received by the transmitting/receiving antenna 101 is amplified by the amplifying section 102. Each transmitting/receiving section 103 receives the UL signal amplified by the amplifying section 102. The transmitting/receiving section 103 performs frequency conversion for the received signal into the baseband signal, and outputs the baseband signal to the baseband signal processing section 104.

In the baseband signal processing section 104, UL data included in the input UL signal is subjected to fast Fourier transform (FFT) processing, inverse discrete Fourier transform (IDFT) processing, error correction decoding, receiving processing for MAC retransmission control, and receiving processing for an RLC layer and a PDCP layer, and the UL data is transferred to the higher station apparatus 30 via the communication path interface 106. The call processing section 105 performs call processing such as configuration and releasing communication channels, manages states of the radio base stations 10, and manages the radio resources.

The communication path interface 106 transmits and receives signals to and from the higher station apparatus 30 via a certain interface. Moreover, the communication path interface 106 may transmit and receive (perform backhaul signaling for) signals with adjacent radio base stations 10 via an inter-base station interface (for example, optical fiber in compliance with CPRI (Common Public Radio Interface), and the X2 interface).

Furthermore, the transmitting/receiving section 103 transmits, to the user terminal 20, a DL signal (including at least one of a DL data signal, a DL control signal (DCI), a DL reference signal, and system information (for example, RMSI, SIB, and MIB)), and receives a UL signal (including at least one of a UL data signal, a UL control signal, and a UL reference signal) from the user terminal 20.

Moreover, the transmitting/receiving section 103 receives UCI from the user terminal 20 using the uplink shared channel (for example, PUSCH) or the uplink control channel (for example, short PUCCH and/or long PUCCH). This UCI may include at least one of HARQ-ACK, CSI, and SR of the DL data channel (for example, PDSCH), beam identification information (for example, beam index (BI)), and a buffer status report (BSR).

Further, the transmitting/receiving section 103 may receive the uplink control information using the uplink control channel. Moreover, the transmitting/receiving section 103 may transmit system information (for example, RMSI) including an index value indicating one or more resources (PUCCH resources) for the uplink control channel. Further, the transmitting/receiving section 103 may transmit downlink control information (downlink control channel) including an index value (for example, ARI) indicating one or more resources for the uplink control channel.

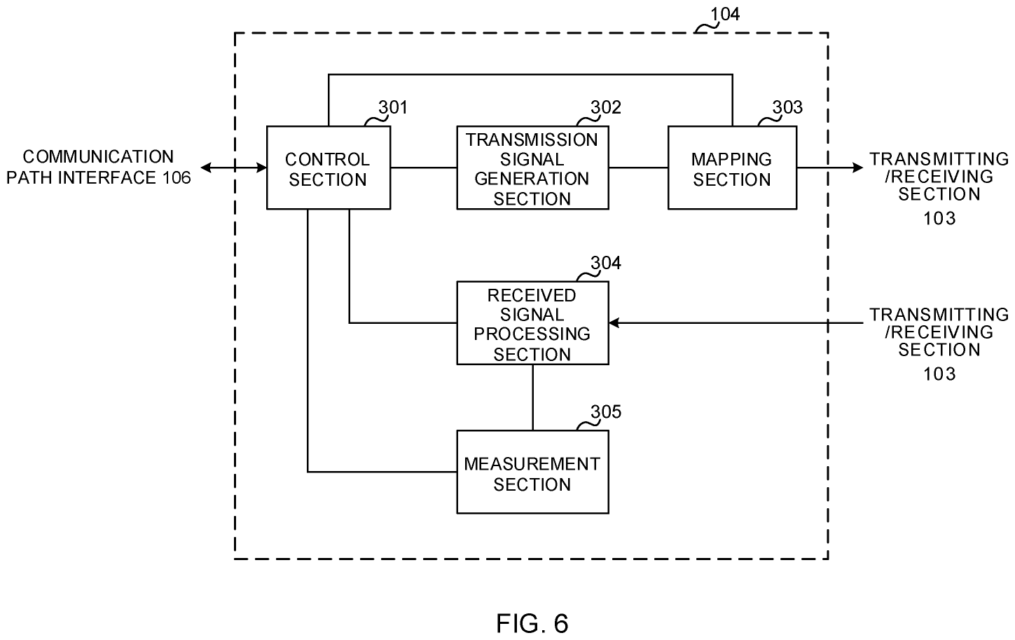

FIG. 6 is a diagram illustrating an example of a functional configuration of the radio base station according to the present embodiment. This drawing mainly illustrates functional blocks of characteristic portions in the present embodiment, and it is assumed that the radio base station 10 has other functional blocks necessary for radio communication as well. As illustrated in this drawing, the baseband signal processing section 104 includes a control section 301, a transmission signal generation section 302, a mapping section 303, a received signal processing section 304, and a measurement section 305.

The control section 301 controls the whole of the radio base station 10. For example, the control section 301 controls generation of such DL signals by the transmission signal generation section 302, mapping of the DL signals by the mapping section 303, receiving processing (for example, demodulation) for such UL signals by the received signal processing section 304, and measurement by the measurement section 305.

Specifically, the control section 301 schedules the user terminal 20. Specifically, the control section 301 may perform scheduling and/or retransmission control for the DL data and/or the uplink shared channel based on UCI (for example, CSI and/or BI) output from the user terminal 20.

Moreover, the control section 301 may control the configuration (format) of the uplink control channel (for example, long PUCCH and/or short PUCCH), and may perform control to transmit control information related to the uplink control channel.

Further, the control section 301 may control the PUCCH resource. Specifically, the control section 301 may determine one or more PUCCH resources to be reported to the user terminal 20. Moreover, the control section 301 may control at least one of generation and transmission of system information (for example, RMSI) indicating at least one of the determined PUCCH resources.

Further, the control section 301 may determine an index value to be included in the system information from among a plurality of index values indicating at least different numbers of PUCCH resources. For example, the control section 301 may determine this index value based on the number of user terminals in the cell.

The control section 301 may control the received signal processing section 304 to perform the receiving processing for UCI output from the user terminal 20 based on the format of the uplink control channel.

Further, before the connection to the user terminal is established (the RRC connection is set up), the control section 301 may control an implicit report of the configuration information for the repeated transmission of the uplink signal (for example, PUCCH) received from the user terminal.

The control section 301 can be composed of a controller, a control circuit, or control apparatus, which is described based on common understanding in the technical field according to the present invention.

The transmission signal generation section 302 generates the DL signals (including the DL data signals, the DL control signals, and the DL reference signals) based on an instruction from the control section 301, and outputs the generated DL signals to the mapping section 303.

The transmission signal generation section 302 can be defined to be a signal generator, a signal generating circuit, or a signal generating apparatus, which is described based on common understanding in the technical field according to the present invention.

The mapping section 303 maps the DL signals, which are generated in the transmission signal generation section 302, to certain radio resources based on instructions from the control section 301, and outputs the mapped DL signals to the transmitting/receiving sections 103. The mapping section 303 can be defined to be a mapper, a mapping circuit, or a mapping apparatus, which is described based on common understanding in the technical field according to the present invention.

The received signal processing section 304 performs receiving processing (for example, demapping, demodulation, decoding, and so on) for the UL signals (for example, including UL data signals, UL control signals, and UL reference signals) transmitted from the user terminal 20. Specifically, the received signal processing section 304 may output, to the measurement section 305, the received signals or the signals already subjected to the receiving processing. Further, the received signal processing section 304 performs receiving processing for UCI based on an uplink control channel configuration on which an instruction is given by the control section 301.

The measurement section 305 conducts measurements for the received signals. The measurement section 305 can be composed of a measurer, a measurement circuit, or measurement apparatus, which is described based on common understanding in the technical field according to the present invention.

The measurement section 305 may measure channel quality of UL, for example, based on received power of the UL reference signal (that is, for example, RSRP (Reference Signal Received Power)) and/or reception quality (for example, RSRQ (Reference Signal Received Quality)). Results of the measurement may be output to the control section 301.

(User Terminal)

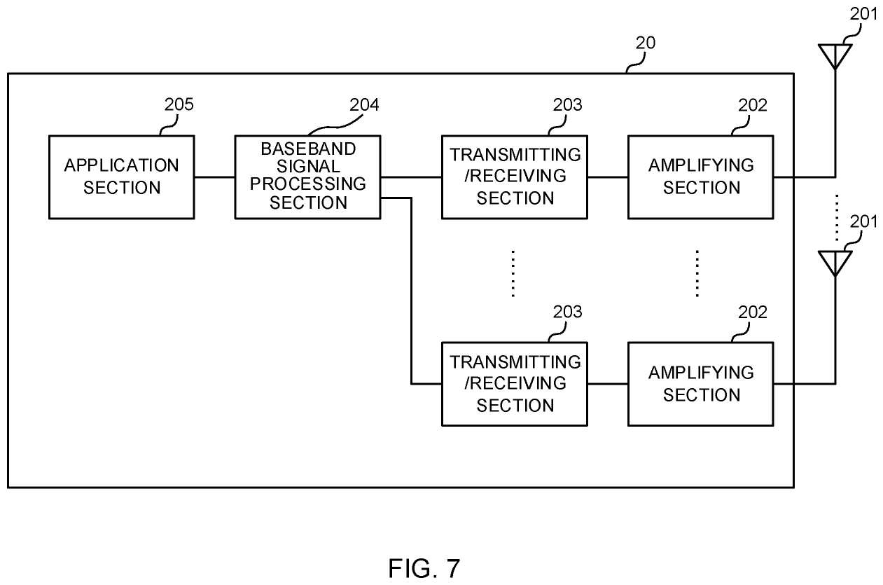

FIG. 7 is a diagram illustrating an example of an overall configuration of a user terminal according to the present embodiment. The user terminal 20 includes a plurality of transmitting/receiving antennas 201 for MIMO transmission, amplifying sections 202, transmitting/receiving sections 203, a baseband signal processing section 204, and an application section 205.

Radio frequency signals received in the plurality of transmitting/receiving antennas 201 are individually amplified in the amplifying sections 202. The respective transmitting/receiving sections 203 receive the DL signals amplified in the amplifying sections 202. The transmitting/receiving sections 203 perform frequency conversion for the received signals into baseband signals, and output the baseband signals to the baseband signal processing section 204.

The baseband signal processing section 204 performs FFT processing, error correction decoding, retransmission control receiving processing, and the like for the input baseband signals. The DL data is transferred to the application section 205. The application section 205 performs processing related to upper layers than a physical layer and a MAC layer, and the like. Further, broadcast information is also transferred to the application section 205.

Meanwhile, the UL data is input from the application section 205 to the baseband signal processing section 204. In the baseband signal processing section 204, transmission processing (for example, transmission processing for HARQ) for the retransmission control, channel coding, rate matching, puncture, discrete Fourier transform (DFT) processing, IFFT processing, and the like are performed for the UL data, and the UL data is transferred to the respective transmitting/receiving sections 203. At least one of channel coding, rate matching, puncturing, DFT processing, and IFFT processing is also performed for UCI, and UCI is transferred to the respective transmitting/receiving sections 203.

Each of the transmitting/receiving sections 203 converts the baseband signal, which is output from the baseband signal processing section 204, into signal in a radio frequency band, and transmits such a radio frequency signal. The radio frequency signal subjected to frequency conversion in the transmitting/receiving section 203 is amplified in the amplifying section 202, and transmitted from each of the transmitting/receiving antennas 201.

Furthermore, for the user terminal 20, the transmitting/receiving section 203 receives the DL signal (including at least one of the DL data signal, the DL control signal (DCI), the DL reference signal, and the system information (for example, RMSI, SIB, and MIB), and transmits the UL signal (including at least one of the UL data signal, the UL control signal, and the UL reference signal) from the user terminal 20.

Moreover, the transmitting/receiving section 203 transmits UCI to the radio base station 10 using the uplink shared channel (for example, PUSCH) or the uplink control channel (for example, short PUCCH and/or long PUCCH).

Further, the transmitting/receiving section 203 may transmit the uplink control information using the uplink control channel. Moreover, the transmitting/receiving section 203 may receive the system information (for example, RMSI) including the index value indicating one or more resources (PUCCH resources) for the uplink control channel. Further, the transmitting/receiving section 103 may receive the downlink control information (downlink control channel) including the index value (for example, ARI) indicating one or more resources for the uplink control channel.

The transmitting/receiving section 203 can be defined to be a transmitter/receiver, a transmitting/receiving circuit, or a transmitting/receiving apparatus, which is described based on common understanding in the technical field according to the present invention. Moreover, the transmitting/receiving section 203 may be composed of an integrated transmitting/receiving section, or may be composed of a transmitting section and a receiving section.

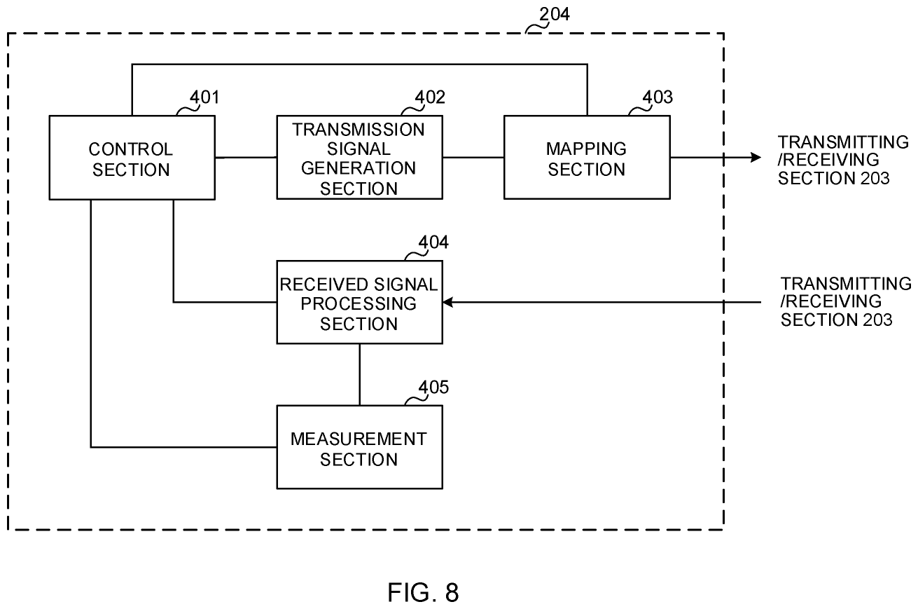

FIG. 8 is a diagram illustrating an example of a functional configuration of the user terminal according to the present embodiment. This drawing mainly illustrates functional blocks of characteristic portions in the present embodiment, and it is assumed that the user terminal 20 has other functional blocks necessary for radio communication as well. As illustrated in this drawing, the baseband signal processing section 204 provided in the user terminal 20 includes a control section 401, a transmission signal generation section 402, a mapping section 403, a received signal processing section 404, and a measurement section 405.

The control section 401 controls the whole of the user terminal 20. For example, the control section 401 controls generation of the UL signals by the transmission signal generation section 402, mapping of the UL signals by the mapping section 403, receiving processing for the DL signals by the received signal processing section 404, and measurement by the measurement section 405.

Moreover, the control section 401 controls the uplink control channel for use in transmitting UCI from the user terminal 20 based on an explicit instruction from the radio base station 10 or an implicit determination in the user terminal 20.

Moreover, the control section 401 may control the configuration (format) of the uplink control channel (for example, long PUCCH and/or short PUCCH). The control section 401 may control the format of the uplink control channel based on the control information from the radio base station 10. Further, the control section 401 may control the PUCCH format (format of the uplink control channel) for use in the transmission of UCI based on information on fallback.

Moreover, the control section 401 may determine the PUCCH resource for use in the transmission of UCI based on at least one of information subjected to upper layer signaling, downlink control information, and an implicit value.

Specifically, in the case of transmitting UCI using the uplink control channel before the setup of the RRC (Radio Resource Control) connection, the control section 401, may determine the resources for the uplink control channels for use in transmitting UCI based on the index in the system information (for example, RMSI).

For example, from among one or more PUCCH resources indicated by the index value included in the system information, the control section 401 may determine the resource for transmitting the uplink control information based on at least one of the bit value and the implicit value in the downlink control information.

Further, the control section 401 may control the repeated transmission of the uplink signal based on the configuration information reported implicitly.

Moreover, the uplink signal may be the uplink control channel (PUCCH) indicating the delivery confirmation information (HARQ-ACK, for example, HARQ-ACK for Msg. 4) in the random access procedure.

Further, the configuration information may be reported by the control resource element (CCE) index of the downlink control channel transmitted before the connection establishment, the downlink assignment indicator (DAI) transmitted by the downlink control channel transmitted before the connection establishment, and Message 2, Message 3, and Message 4.

Moreover, when the repeated transmission is configured by the configuration information, and the user terminal supports the repeated transmission, then the control section 401 may transmit a plurality of the uplink control channels.

Meanwhile, when the repeated transmission is configured by the configuration information, and the user terminal does not support the repeated transmission, then the control section 401 may transmit a single uplink control channel.

The control section 401 can be composed of a controller, a control circuit, or control apparatus, which is described based on common understanding in the technical field according to the present invention.

The transmission signal generation section 402 performs generation (for example, encoding, rate matching, puncture, modulation, and the like) of the UL signals (including UL data signals, UL control signals, UL reference signals, and UCIs) based on an instruction from the control section 401, and outputs the generated UL signals to the mapping section 403. The transmission signal generation section 402 can be defined to be a signal generator, a signal generating circuit, or a signal generating apparatus, which is described based on common understanding in the technical field according to the present invention.

The mapping section 403 maps the UL signals, which are generated in the transmission signal generation section 402, to the radio resources based on instructions from the control section 401, and outputs the mapped UL signals to the transmitting/receiving sections 203. The mapping section 403 can be defined to be a mapper, a mapping circuit, or a mapping apparatus, which is described based on common understanding in the technical field according to the present invention.

The received signal processing section 404 performs receiving processing (for example, demapping, demodulation, decoding, and so on) for the DL signals (DL data signals, scheduling information, DL control signals, and DL reference signals). The received signal processing section 404 outputs, to the control section 401, the information received from the radio base station 10. The received signal processing section 404 outputs, for example, broadcast information, system information, upper layer control information by upper layer signaling such as RRC signaling, physical layer control information (L1/L2 control information), or the like to the control section 401.

The received signal processing section 404 can be composed of a signal processor, a signal processing circuit, or a signal processing apparatus, which is described based on common understanding in the technical field according to the present invention. Moreover, the received signal processing section 404 can constitute a receiving section according to the present invention.

The measurement section 405 measures a channel state based on a reference signal (for example, CSI-RS) output from the radio base station 10, and outputs a result of the measurement to the control section 401. The channel state may be measured for each CC.

The measurement section 405 can be composed of a signal processor, a signal processing circuit, or a signal processing apparatus, and a measurer, measurement circuit, or a measurement apparatus, which are described based on common understanding in the technical field according to the present invention.

(Hardware Configuration)

The block diagrams used for the description of the above embodiment illustrate blocks in functional units. These functional blocks (components) are achieved by any combination of at least one of hardware components and software components. Further, a method of achieving each functional block is not particularly limited. That is, each functional block may be achieved by a single apparatus physically or logically aggregated, or may be achieved by directly or indirectly connecting two or more physically or logically separate apparatuses (using wires, radio, or the like, for example) and using these plural apparatuses.

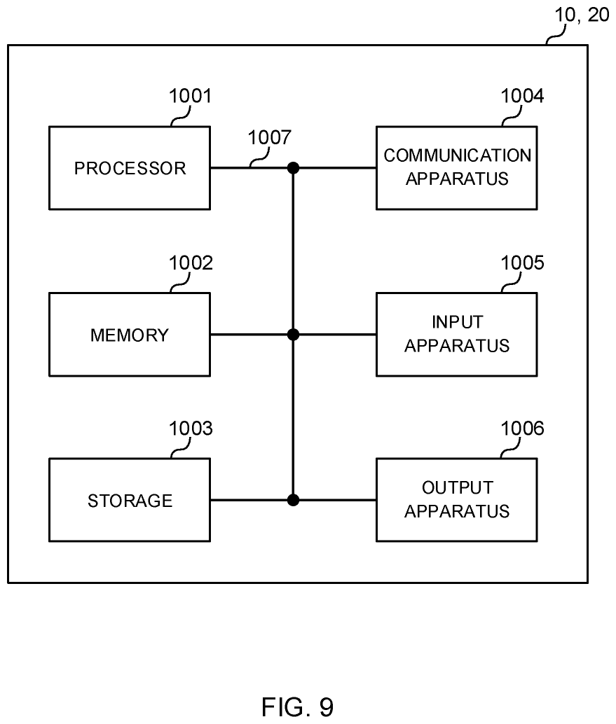

For example, the radio base station, the user terminal, or the like in the embodiment of the present disclosure may function as a computer that performs the processing of the radio communication method of the present disclosure. FIG. 9 is a diagram illustrating an example of a hardware configuration of each of the radio base station and the user terminal according to the embodiment. Physically, each of the above-mentioned radio base station 10 and user terminal 20 may be composed as a computer apparatus including a processor 1001, a memory 1002, a storage 1003, a communication apparatus 1004, an input apparatus 1005, an output apparatus 1006, a bus 1007, and the like.

In the following description, the word “apparatus” may be replaced by “circuit”, “device”, “unit”, and the like. The hardware configuration of each of the radio base station 10 and the user terminal 20 may be composed so as to include one or plurality of each apparatus illustrated in the drawing, or may be composed so as not to include a part of the apparatuses.

For example, although only one processor 1001 is illustrated, a plurality of processors may be provided. Furthermore, the processing may be executed by one processor, or the processing may be executed at the same time, in sequence, or in different manners by one or more processors. Note that the processor 1001 may be implemented by one or more chips.

Each function of the radio base station 10 and the user terminal 20 is achieved, for example, in such a manner that, by causing hardware such as the processor 1001 and the memory 1002 to read certain software (program), the processor 1001 performs a computation, controls communication via the communication apparatus 1004, controls at least one of reading and writing of data in the memory 1002 and the storage 1003, and so on.

For example, the processor 1001 operates an operating system to control the whole of the computer. The processor 1001 may be composed of a central processing unit (CPU) including an interface with peripheral apparatuses, a control apparatus, a computing apparatus, a register, and the like. For example, the baseband signal processing section 104 (204), the call processing section 105 and the like, which are mentioned above, may be achieved by the processor 1001.

Furthermore, the processor 1001 reads the program (program code), a software module, data, and the like from at least one of the storage 1003 and the communication apparatus 1004, into the memory 1002, and executes a variety of processing according to these. As the program, used is a program that causes the computer to execute at least part of the operations described in the above-mentioned embodiment. For example, the control section 401 of the user terminal 20 may be achieved by a control program that is stored in the memory 1002 and operates in the processor 1001, and other functional blocks may be achieved likewise.

The memory 1002 is a computer-readable recording medium, and for example, may be composed of at least one of a ROM (Read Only Memory), an EPROM (Erasable Programmable ROM), an EEPROM (Electrically EPROM), a RAM (Random Access Memory), and other appropriate storage media. The memory 1002 may be called a register, a cache, a main memory (primary storage apparatus), and the like. The memory 1002 can store a program (program code), a software module, and the like, which are executable for implementing the radio communication method according to the embodiment of the present disclosure.

The storage 1003 is a computer-readable recording medium, and for example, may be composed of at least one of a flexible disk, a floppy (registered trademark) disk, a magneto-optical disk (for example, a compact disc (CD-ROM (Compact Disc ROM) and the like), a digital versatile disc, a Blu-ray (registered trademark) disk), a removable disk, a hard disk drive, a smart card, a flash memory device (for example, a card, a stick, and a key drive), a magnetic stripe, a database, a server, and other appropriate storage media. The storage 1003 may be called an auxiliary storage apparatus.

The communication apparatus 1004 is hardware (transmitting/receiving device) for performing inter-computer communication via at least one of a wired network and a wireless network, and for example, is referred to as “network device”, “network controller”, “network card”, “communication module”, and the like. The communication apparatus 1004 may be composed by including a high frequency switch, a duplexer, a filter, a frequency synthesizer, and the like, for example, in order to achieve at least one of frequency division duplex (FDD) and time division duplex (TDD). For example, the transmitting/receiving antennas 101 (201), the amplifying sections 102 (202), the transmitting/receiving sections 103 (203), the communication path interface 106, and the like, which are mentioned above, may be achieved by the communication apparatus 1004.

The input apparatus 1005 is an input device (for example, a keyboard, a mouse, a microphone, a switch, a button, a sensor, and the like) that receives an input from the outside. The output apparatus 1006 is an output device (for example, a display, a speaker, an LED (Light Emitting Diode) lamp, and the like) that implements an output to the outside. The input apparatus 1005 and the output apparatus 1006 may have an integrated configuration (for example, a touch panel).

Furthermore, the respective apparatuses such as the processor 1001 and the memory 1002 are connected to one another by the bus 1007 for information communication. The bus 1007 may be composed using a single bus, or may be composed using buses different between the apparatuses.

Furthermore, the radio base station 10 and the user terminal 20 may be configured by including hardware such as a microprocessor, a digital signal processor (DSP), an ASIC (Application-Specific Integrated Circuit), a PLD (Programmable Logic Device), and an FPGA (Field Programmable Gate Array), and a part or all of each of the functional blocks may be achieved using the hardware. For example, the processor 1001 may be implemented using at least one of these pieces of hardware.

### MODIFIED EXAMPLE

The terms described in the present disclosure and the terms necessary to understand the present disclosure may be replaced by terms having the same or similar meanings. For example, at least one of the channel and the symbol may be a signal (signaling). Further, the signal may be a message. The reference signal may be abbreviated as RS (Reference Signal), and may be called a pilot, a pilot signal, or the like depending on a standard to be applied. Furthermore, the component carrier (CC) may be called a cell, a frequency carrier, a carrier frequency, and the like.

The radio frame may be composed of one or more periods (frames) in the time domain. Each of the one or more periods (frames) which constitute the radio frame may be called a subframe. Furthermore, the subframe may be composed of one or more slots in the time domain. The subframe may have a fixed time length (for example, 1 ms) that does not depend on numerology.

Here, the numerology may be a communication parameter applied to at least one of transmission and reception of a certain signal or channel. For example, the numerology may indicate at least one of a subcarrier spacing (SCS), a bandwidth, a symbol length, a cyclic prefix length, a transmission time interval (TTI), the number of symbols per TTI, a radio frame configuration, specific filtering processing to be performed by a transceiver in the frequency domain, specific windowing processing to be performed by the transceiver in the time domain, and the like.

The slot may be composed of one or more symbols (OFDM (Orthogonal Frequency Division Multiplexing) symbols, SC-FDMA (Single Carrier Frequency Division Multiple Access) symbols, and the like) in the time domain. Further, the slot may be a unit of time based on numerology.

The slot may include a plurality of minislots. Each minislot may be comprised of one or more symbols in the time domain. Further, the minislot may be called a subslot. The minislot may be composed of a smaller number of symbols than that of such slots. PDSCH (or PUSCH) transmitted in a unit of time, which is larger than the minislot, may be called PDSCH (PUSCH) mapping type A. PDSCH (or PUSCH) transmitted using the minislot may be called PDSCH (PUSCH) mapping type B.

Each of the radio frame, the subframe, the slot, the minislot, and the symbol represents a unit of time at the time of transmitting a signal. Each of the radio frame, the subframe, the slot, the minislot, and the symbol may be called another name corresponding thereto.

For example, one subframe may be called a transmission time interval (TTI), or a plurality of consecutive subframes may be called the TTI, or one slot or minislot may be called the TTI. That is, at least one of the subframe and TTI may be a subframe (1 ms) in the existing LTE, may be a shorter period (for example, 1 to 13 symbols) than 1 ms, or may be a longer period than 1 ms. The unit that represents TTI may be called a slot, a mini slot, and the like, instead of the subframe.

Here, TTI refers to the minimum unit of time of scheduling in radio communication, for example. For example, in LTE systems, the radio base station performs scheduling for allocating radio resources to each user terminal in a unit of TTI, the radio resources including the frequency bandwidth, transmission power, and the like, which are usable in each user terminal. The definition of TTIs is not limited to this.

TTI may be a unit of time of transmitting channel-encoded data packets (transport blocks), code blocks, codewords, and the like, or may be a unit of processing for scheduling, link adaptation, and the like. When TTI is given, a time interval (for example, the number of symbols) in which the transport blocks, the code blocks, the codewords, and the like are actually mapped may be shorter than TTI.

When one slot or one minislot is called TTI, one or more TTIs (that is, one or more slots or one or more minislots) may be the minimum unit of time of scheduling. Moreover, the number of slots (the number of minislots) which constitute the minimum unit of time of the scheduling may be controlled.

TTI having a time length of 1 ms may be called usual TTI (TTI in LTE Rel. 8 to 12), normal TTI, long TTI, a usual subframe, a normal subframe, a long subframe, or the like. TTI shorter than the usual TTI may be called a shortened TTI, a short TTI, a partial TTI (or a fractional TTI), a shortened subframe, a short subframe, a minislot, a subslot, or the like.

The long TTI (for example, the usual TTI, the subframe, and the like) may be replaced by TTI having a time length exceeding 1 ms, and the short TTI (for example, the shortened TTI and the like) may be replaced by TTI having a TTI length less than the TTI length of the long TTI and not less than 1 ms.

The resource block (RB) is the unit of resource allocation in the time domain and the frequency domain, and may include one or plurality of consecutive subcarriers in the frequency domain.

Moreover, RB may include one or plurality of symbols in the time domain, and may be one slot, one minislot, one subframe, or one TTI in length. One TTI and one subframe may be each composed of one or more resource blocks.

One or more RBs may be called a physical resource block (PRB (Physical RB)), a subcarrier group (SCG), a resource element group (REG), a PRB pair, an RB pair, or the like.

Furthermore, the resource block may be composed of one or more resource elements (REs). For example, one RE may be a radio resource region of one subcarrier and one symbol.

Structures of the radio frames, the subframes, the slots, the minislots, the symbols, and the like, which are mentioned above, are merely examples. For example, configurations pertaining to the number of subframes included in a radio frame, the number of slots included in a subframe or a radio frame, the number of minislots included in a slot, the number of symbols and RBs, which are included in a slot or a minislot, the number of subcarriers included in RB, the number of symbols in TTI, the symbol duration, the length of cyclic prefixes (CPs), and the like can be variously changed.

Moreover, the information, the parameters, and the like, which are described in the present disclosure, may be represented in absolute values or in relative values with respect to certain values, or may be represented using other applicable information. For example, a radio resource may be specified by a certain index.

The names used for parameters and the like in the present disclosure are in no respect limiting. For example, since various channels (PUCCH (Physical Uplink Control Channel), PDCCH (Physical Downlink Control Channel) and the like) and information elements can be identified by any suitable names, the various names assigned to these individual channels and information elements are in no respect limiting.

The information, signals, and the like, which are described in the present disclosure, may be represented using a variety of different technologies. For example, data, instructions, commands, information, signals, bits, symbols, and chips, and so on, all of which may be referenced throughout the herein-contained description, may be represented by voltages, currents, electromagnetic waves, magnetic fields, or particles, optical fields or photons, or any combination of these.

Further, information, signals and the like can be output in at least one of a direction from upper layers to lower layers and a direction from lower layers to upper layers. Information, signals, and the like may be input and output via a plurality of network nodes.

The information, signals, and the like, which are input and output, may be stored in a specific location (for example, in a memory), or may be managed in a control table. The information, signals, and the like, which are to be input and output can be overwritten, updated, or appended. The information, signals, and the like, which are output, may be deleted. The information, signals, and the like, which are input, may be transmitted to other apparatuses.

The reporting of information is by no means limited to the aspects/embodiments described in the present disclosure, and may be performed using other methods. For example, the reporting of information may be implemented by physical layer signaling (for example, downlink control information (DCI), uplink control information (UCI)), upper layer signaling (for example, RRC (Radio Resource Control) signaling, broadcast information (master information block (MIB), system information block (SIB), and the like), and MAC (Medium Access Control) signaling), other signals or combinations of these.

The physical layer signaling may be called L1/L2 (Layer 1/Layer 2) control information (L1/L2 control signals), L1 control information (L1 control signal), and so on. Further, the RRC signaling may be called RRC messages, and may be, for example, an RRC connection setup (RRCConnectionSetup) message, an RRC connection reconfiguration (RRCConnectionReconfiguration) message, and the like. Moreover, the MAC signaling may be reported using, for example, MAC control elements (MAC CEs).

Further, reporting of certain information (for example, reporting of information to the effect that “X holds”) does not necessarily have to be sent explicitly, and may be sent implicitly (for example, by not reporting this certain information, or by reporting another piece of information).

Determination may be made by values represented by one bit (0 or 1), may be made by Boolean values which represent true or false, or may be made by comparing numerical values (for example, comparison with a certain value).

No matter whether to be called software, firmware, middleware, a microcode, or a hardware description language or to be called by other names, software should be interpreted broadly so as to mean instructions, instruction sets, codes, code segments, program codes, programs, subprograms, software modules, applications, software applications, software packages, routines, subroutines, objects, executable files, execution threads, procedures, functions, and the like.

Further, software, commands, information, and the like may be transmitted and received via transmission media. For example, when software is transmitted from a website, a server, or other remote sources using at least one of wired technologies (coaxial cables, optical fiber cables, twisted-pair cables, digital subscriber lines (DSLs), and the like) and wireless technologies (infrared radiation, microwaves, and the like), at least one of these wired technologies and wireless technologies are also included in the definition of transmission media.

The terms “system” and “network” for use in the present disclosure are usable interchangeably.

In the present disclosure, terms such as “base station (BS)”, “radio base station”, “fixed station”, “NodeB”, “eNodeB (eNB)”, “gNodeB (gNB)”, ““access point”, “transmission point”, “reception point”, “transmission/reception point”, “cell”, “sector”, “cell group”, “carrier”, “component carrier”, and “bandwidth part (BWP)” are usable interchangeably. The base station may be called a term such as a macro cell, a small cell, a femto cell, a pico cell, and the like.

The base station can accommodate one or more (for example, three) cells (also called sectors). When the base station accommodates a plurality of cells, the entire coverage area of the base station can be partitioned into a plurality of smaller areas, and each smaller area can provide communication services through base station subsystems (for example, indoor small base stations (RRHs (Remote Radio Heads))). The term “cell” or “sector” refers to part or all of the coverage area of at least one of the base station and the base station subsystem, which provides communication services within this coverage.

In the present disclosure, the terms such as “mobile station (MS)”, “user terminal”, “user equipment (UE)”, and “terminal” are usable interchangeably.

The mobile station may be called a subscriber station, a mobile unit, a subscriber unit, a wireless unit, a remote unit, a mobile device, a wireless device, a wireless communication device, a remote device, a mobile subscriber station, an access terminal, a mobile terminal, a wireless terminal, a remote terminal, a handset, a user agent, a mobile client, a client, or some other suitable terms.

At least one of the base station and the mobile station may be called a transmitting device, a receiving device, or the like. At least one of the base station and the mobile station may be a device mounted on a mobile body, the mobile body itself, or the like. The mobile body may be a vehicle (for example, car, airplane, or the like), a mobile body moving unmanned (for example, drone, autonomous vehicle, or the like), or a (manned or unmanned) robot. At least one of the base station and the mobile station includes a device that does not necessarily move during a communication operation.

Furthermore, the radio base stations in the present disclosure may be replaced by user terminals. For example, each aspect/embodiment of the present disclosure may be applied to a configuration in which communication between a radio base station and a user terminal is replaced by communication among a plurality of user terminals (for example, the communication may be called D2D (Device-to-Device), V2X (Vehicle-to-Everything), and the like). In this case, the user terminals 20 may have the functions of the radio base stations 10 mentioned above. Further, the words such as “uplink” and “downlink” may be replaced by a word (for example, “side”) corresponding to inter-terminal communication. For example, an uplink channel, a downlink channel, and the like may be replaced by side channels.

Likewise, the user terminals in the present disclosure may be replaced by radio base stations. In this case, the radio base stations 10 may have the functions of the user terminals 20 mentioned above.

Certain actions which have been described in the present disclosure to be performed by base stations may, in some cases, be performed by upper nodes thereof. In a network including one or more network nodes having base stations, it is clear that various operations performed in order to communicate with terminals can be performed by base stations, one or more network nodes (for example, MMEs (Mobility Management Entities), S-GWs (Serving-Gateways), and the like are conceived, but these are not limiting) other than base stations, or combinations of these.

Each aspect/embodiment described in the present disclosure may be used alone, may be used in combination, or may be switched and used according to execution. Further, the processing procedures, the sequences, the flowcharts, and the like in each aspect/embodiment described in the present disclosure may be re-ordered as long as there is no contradiction. For example, regarding the methods described in the present disclosure, elements of various steps are presented in an illustrative order, and are not limited to the presented particular order.

Each aspect/embodiment described in the present disclosure may be applied to LTE (Long Term Evolution), LTE-A (LTE-Advanced), LTE-B (LTE-Beyond), SUPER 3G, IMT-Advanced, 4G (4th generation mobile communication system), 5G (5th generation mobile communication system), FRA (Future Radio Access), New-RAT (Radio Access Technology), NR (New Radio), NX (New radio access), FX (Future generation radio access), GSM (registered trademark) (Global System for Mobile communications), CDMA 2000, UMB (Ultra Mobile Broadband), IEEE 802.11 (Wi-Fi (registered trademark)), IEEE 802.16 (WiMAX (registered trademark)), IEEE 802.20, UWB (Ultra-WideBand), Bluetooth (registered trademark), systems that use other appropriate radio communication methods, next-generation systems extended based thereon, and the like. Further, a plurality of systems may be combined and applied (for example, a combination of LTE or LTE-A and 5G).

The description “based on” used in the present disclosure does not mean “based on only”, unless otherwise specified. In other words, the description “based on” means both of “based on only” and “based on at least”.

Any references to elements using designations such as “first” and “second” used in the present disclosure do not limit the amount or order of these elements overall. In the present disclosure, these designations are usable as the useful method for distinguishing two or more elements. Hence, references of first and second elements do not mean that only two elements are adoptable, or that the first element must precede the second element in some way.

There is a case where the term of “determining” used in the present disclosure includes various types of operations. For example, “determining” may be regarded as “determining” judging, calculating, computing, processing, deriving, investigating, looking up (for example, looking up in a table, database, or another data structure), ascertaining, and the like.

Further, “determining” may be regarded as “determining” receiving (for example, receiving information), transmitting (for example, transmitting information), input, output, accessing (for example, accessing data in memory), and the like.

Furthermore, “determining” may be regarded as “determining” resolving, selecting, choosing, establishing, comparing, and the like. In other words, “determining” may be regarded as “determining” some operation.

Further, “determining” may be replaced by “assuming”, “expecting”, “considering”, and the like.

“Maximum transmission power” described in the present disclosure may mean a maximum value of transmission power, may mean the nominal UE maximum transmit power, or may mean the rated UE maximum transmit power.

The terms “connected” and “coupled” used in the present disclosure or any modifications thereof mean every direct or indirect connection or coupling among two or more elements, and can include the presence of one or more intermediate elements between two mutually “connected” or “coupled” elements. Coupling or connection between elements may be physical, may be logical, or may be a combination thereof. For example, “connection” may be replaced by “access”.

In the present disclosure, when two elements are connected to each other, these elements can be considered “connected” or “coupled” to each other by using one or more electrical wires, cables, printed electrical connections, and the like, and, as a number of non-limiting and non-inclusive examples, by using electromagnetic energy having wavelengths in a radio frequency domain, a microwave domain, an optical (both visible and invisible) domain, and the like.

In the present disclosure, the phrase “A and B are different” may mean “A and B are different from each other”. The terms such as “leave” and “coupled” may be interpreted as well.

Where the terms “include”, “including”, and variations thereof are used in the present disclosure, these terms are intended to be inclusive as is the term “comprising”. Further, the term “or” used in the present disclosure is intended to be not exclusive OR.

For example, when articles, such as “a”, “an”, and “the” in English, are added by translation in the present disclosure, the present disclosure may include that nouns which follows these articles are in plural.

Now, although invention according to the present disclosure has been described above in detail, it is obvious to those skilled in the art that the invention according to the present disclosure is by no means limited to the embodiments described in the present disclosure. The invention according to the present disclosure can be implemented with various corrections and in various modifications, without departing from the spirit and scope of the invention defined by the recitations of claims. Hence, the description of the present disclosure is provided only for the purpose of explaining examples, and should by no means be construed to limit the invention according to the present disclosure in any way.

This application is based on Japanese Patent Application No. 2018-089524 filed on Apr. 16, 2018. All of this content is included here.

1. A user terminal comprising:
a transmitting section that transmits an uplink signal before connection establishment; and
a control section that controls a repeated transmission of the uplink signal based on configuration information reported implicitly.

2. The user terminal according to claim 1, wherein the uplink signal is an uplink control channel indicating delivery confirmation information in a random access procedure.

3. The user terminal according to claim 1, wherein the configuration information is reported by a control resource element index of a downlink control channel transmitted before the connection establishment, a downlink assignment indicator transmitted by the downlink control channel transmitted before the connection establishment, and Message 2, Message 3, and Message 4.

4. The user terminal according to claim 1, wherein, when the repeated transmission is configured by the configuration information, and the user terminal supports the repeated transmission, then the control section transmits a plurality of the uplink control channels.

5. The user terminal according to claim 1, wherein, when the repeated transmission is configured by the configuration information, and the user terminal does not support the repeated transmission, then the control section transmits a single uplink control channel.

6. A radio base station comprising:
a receiving section that receives an uplink signal from a user terminal before a connection to the user terminal is established; and
a control section that controls an implicit report of configuration information for repeated transmission of the uplink signal.

7. The user terminal according to claim 2, wherein the configuration information is reported by a control resource element index of a downlink control channel transmitted before the connection establishment, a downlink assignment indicator transmitted by the downlink control channel transmitted before the connection establishment, and Message 2, Message 3, and Message 4.

8. The user terminal according to claim 2, wherein, when the repeated transmission is configured by the configuration information, and the user terminal supports the repeated transmission, then the control section transmits a plurality of the uplink control channels.

9. The user terminal according to claim 3, wherein, when the repeated transmission is configured by the configuration information, and the user terminal supports the repeated transmission, then the control section transmits a plurality of the uplink control channels.

10. The user terminal according to claim 2, wherein, when the repeated transmission is configured by the configuration information, and the user terminal does not support the repeated transmission, then the control section transmits a single uplink control channel.

11. The user terminal according to claim 3, wherein, when the repeated transmission is configured by the configuration information, and the user terminal does not support the repeated transmission, then the control section transmits a single uplink control channel.

12. The user terminal according to claim 4, wherein, when the repeated transmission is configured by the configuration information, and the user terminal does not support the repeated transmission, then the control section transmits a single uplink control channel.
